(19) United States
(12) Patent Application Publication
(10) Pub. No.: US 2021/0088371 A1
(43) Pub. Date: Mar. 25, 2021

(54) TANK VOLUME MONITORING USING SENSED FLUID PRESSURE

(71) Applicant: Graco Minnesota Inc., Minneapolis, MN (US)

(72) Inventor: Kelly L. Shanks, Eagan, MN (US)

(21) Appl. No.: 16/644,857

(22) PCT Filed: Sep. 7, 2018
(86) PCT No.: PCT/US18/49827

§ 371 Date: Mar. 5, 2020

Related U.S. Application Data
(60) Provisional application No. 62/555,508, filed on Sep. 7, 2017.

(51) Int. Cl. G01F 23/18; G01F 23/00

(52) U.S. Cl. CPC G01F 23/18; G01F 23/0076

(57) ABSTRACT

Tank volume monitoring using pressure of fluid in the tank includes determining a correlation scale that relates sensed fluid pressure to volume of fluid within the tank. Inputs utilized to determine the correlation scale include, for example, various combinations of sensed pressure for a provided volume, a volume corresponding to a pressure sensor location, a threshold tank volume, a height of fluid above a base of the tank, and reference heights and corresponding volumes of the tank. The correlation scale is determined without requiring the input of linear dimensions of the tank.

### CROSS-REFERENCE TO RELATED APPLICATION

This application claims priority to U.S. Provisional Application No. 62/555,508 filed Sep. 7, 2017, and entitled “TANK VOLUME CONTROLLER,” the disclosure of which is hereby incorporated in its entirety.

### BACKGROUND

The present disclosure relates generally to fluid monitoring, and in particular to the monitoring of fluid levels in a tank using sensed fluid pressure.

The monitoring of fluid levels in storage tanks has become increasingly important to ensure that operations, such as oil and natural gas operations, remain uninterrupted. For example, oil and natural gas operations may rely upon a fracking fluid to prevent corrosion and prevent blockage of the well. Without the fracking fluid, drilling operations would cease and oil or natural gas would not be extracted. Many other industries have similar reliance upon one or more fluids held in storage tanks, such as in chemical production and other related chemical engineering-based industries. Therefore, it is important to be able to timely, continuously, and automatically monitor storage tank volumes, and to communicate current tank volumes and/or alarms for warning when a tank volume has reached a designated volume.

Fluid volume within tanks has been monitored by correlating a fluid pressure in the tank (acquired by a pressure sensor mounted at a fixed position) to a corresponding fluid volume. Typically, such monitoring techniques utilize at least two linear dimensions of the tank to calculate a correlation scale that relates sensed pressure with fluid volume within the tank. Acquiring the linear dimensions of the tank, however, frequently requires manual measuring of the tank, which can be difficult, particularly when the tank is very large and/or installation location prevents such manual measurements. Moreover, some tank shapes cannot be described absent a large number of linear dimensions.

### SUMMARY

In one example, a method includes receiving, by a controller device, an indication of a first volume of fluid within a tank, receiving, by the controller device, an indication of a sensor volume of fluid corresponding to a volume of the fluid in the tank at a location of a pressure sensor, and receiving, by the controller device from the pressure sensor, a signal representing a first sensed pressure of the fluid within the tank corresponding to the first volume of fluid. The method further includes determining, by the controller device, a correlation scale for the tank based on the first sensed pressure, the first volume of fluid, and the sensor volume of fluid. The method further includes receiving, by the controller device from the pressure sensor, a second sensed pressure of the fluid within the tank, determining, by the controller device, a second volume of fluid within the tank based on the second sensed pressure and the correlation scale, and outputting, by the controller device, an indication of the second volume of fluid.

In another example, a controller device includes processing circuitry and computer-readable memory. The computer-readable memory is encoded with instructions that, when executed by the processing circuitry, cause the controller device to determine a correlation scale for a tank based on a received indication of a first volume of fluid within a tank, a first pressure of the first volume of fluid within the tank sensed by a pressure sensor disposed at a location, and a received indication of a sensor volume of fluid corresponding to a volume of the fluid in the tank at the location of the pressure sensor. The computer-readable memory is further encoded with instructions that, when executed by the processing circuitry, cause the controller device to determine a second volume of fluid within the tank based on the correlation scale and a second pressure of the second volume of fluid within the tank sensed by the pressure sensor, and output an indication of the second volume of fluid.

In another example, a method includes receiving, by a controller device, an indication of a first height of a first volume of fluid within a tank, the first height extending above a base of the tank. The method further includes receiving, by the controller device, an indication of at least one height extending above the base of the tank and a corresponding reference volume of the tank at the at least one height, and receiving, by the controller from a pressure sensor, a first sensed pressure signal of the fluid within the tank corresponding to the first volume of fluid. The method further includes determining, by the controller device, a first correlation scale for the tank based on the first sensed pressure and the first height of the first volume of fluid within the tank. The first correlation scale correlates pressure sensed by the pressure sensor to height of the fluid within the tank. The method further includes determining, by the controller device, a second correlation scale for the tank based on the received indication of the at least one height extending above the base of the tank and the corresponding reference volume of the at least one height. The second correlation scale correlates height above the base of the tank to volume of fluid within the tank. The method further includes receiving, by the controller device from the pressure sensor, a second sensed pressure signal of the fluid within the tank, determining, by the controller device, a second height extending above the base of the tank based on the second sensed pressure and the first correlation scale, and determining, by the controller device, a second volume of fluid within the tank based on the second height and the second correlation scale. The method further includes outputting, by the controller device, an indication of the second volume of fluid.

In another example, a controller device includes processing circuitry and computer-readable memory. The computer-readable memory is encoded with instructions that, when executed by the processing circuitry, cause the controller device to determine a first correlation scale for a tank based on a first sensed pressure signal of a first volume of fluid within the tank received from a pressure sensor and a first height of the first volume of fluid within the tank, the first correlation scale correlating pressure sensed by the pressure sensor to height of the fluid within the tank. The computer-readable memory is further encoded with instructions that, when executed by the processing circuitry, cause the controller device to determine a second correlation scale for the tank based a received indication of at least one height extending above a base of the tank and a corresponding reference volume of the tank at the least one height, the second correlation scale correlating height above the base of the tank to volume of fluid within the tank. The computer-readable memory is further encoded with instructions that, when executed by the processing circuitry, cause the controller device to determine a second height extending above the base of the tank based on the second correlation scale and a second sensed pressure signal of fluid within the tank received from the pressure sensor, determine a second volume of fluid within the tank based on the second height and the second correlation scale, and output an indication of the second volume of fluid.

### BRIEF DESCRIPTION OF THE DRAWINGS

FIG. 1 is a schematic block diagram of an example tank volume monitoring and control system.

FIG. 2 is a schematic block diagram showing further details of a tank controller.

FIG. 3A is a perspective view of a vertically-oriented tank having a consistent cross-section along a height dimension of the tank.

FIG. 3B is a flow diagram illustrating example operations of the tank controller to determine a volume of fluid within the tank of FIG. 3A.

FIG. 4A is a perspective view of a horizontally-oriented tank having an inconsistent horizontal cross-section along a height dimension of the tank.

FIG. 4B is a flow diagram illustrating example operations of the tank controller to determine a volume of fluid within the tank of FIG. 4A.

FIG. 5A is a perspective view of a custom tank having an inconsistent horizontal cross-section along a height dimension of the tank. FIG. 5B is a flow diagram illustrating example operations of the tank controller to determine a volume of fluid within the tank of FIG. 5A.

### DETAILED DESCRIPTION

As described herein, a controller device determines a volume of fluid within a tank using fluid pressure acquired by a pressure sensor. Rather than require that the controller device be provided with two or more linear dimensions of the tank, techniques of this disclosure enable the controller device to determine the fluid volume within the tank using inputs that are more readily available to an operator, such as the current volume of fluid within the tank at the time of initialization and an upper threshold volume of the tank (e.g., a maximum fluid capacity of the tank). Accordingly, techniques described herein can enable an operator to more easily initialize the system for fluid volume monitoring, thereby decreasing the time, effort, and cost of the initialization and generally increasing usability of the system.

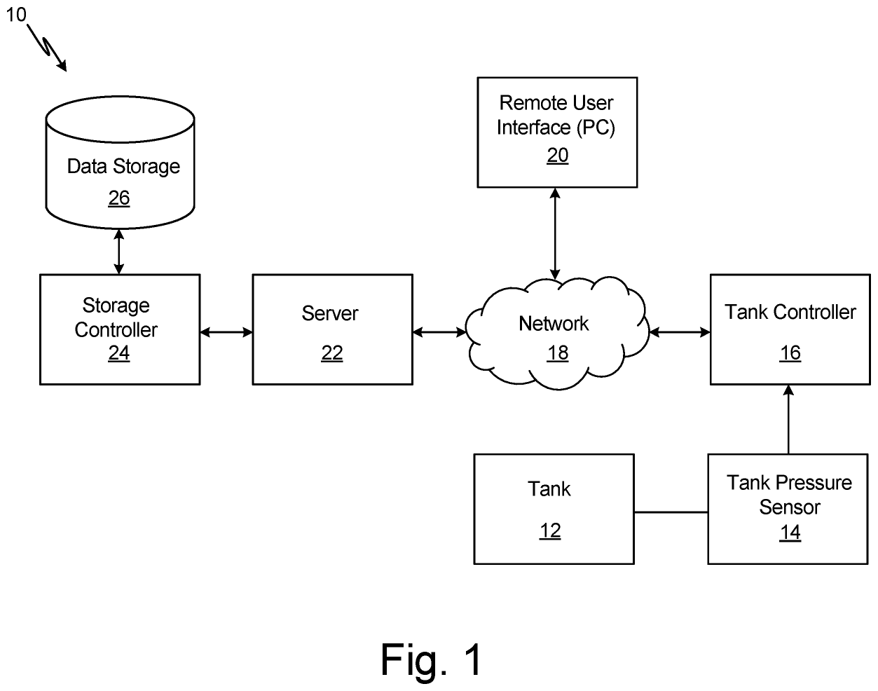

FIG. 1 is a schematic block diagram of tank volume monitoring and control system 10. As illustrated in FIG. 1, tank volume monitoring and control system 10 includes tank 12, tank pressure sensor 14, tank controller 16, network 18, remote user interface 20, server 22, storage controller 24, and data storage 26.

Tank 12 is a storage tank configured to store liquid used for e.g., oil and natural gas operations, chemical production applications, or any other operation in which a liquid is used. Tank 12, as is further described below, can take the form of any shape and orientation having a cross-section that is consistent (i.e., invariant) or inconsistent (i.e., varying) along a height dimension of the tank that is generally aligned with gravity. For instance, tank 12 can be a cylindrical tank having a length that is oriented vertically or horizontally. Tank 12, in some examples, can be non-cylindrical, such as having a square, triangular, hexagonal, or other cross section and oriented such that a length of tank 12 generally aligns with gravity (a vertical orientation), is perpendicular to gravity (a horizontal orientation), or other orientations. In certain examples, tank 12 can be a custom shape having a cross-sectional area that is consistent or inconsistent along a height dimension of tank 12.

Tank pressure sensor 14 is a pressure transducer or other pressure sensor that converts sensed pressure to an electrical signal indicative of the sensed pressure. As is further described below, tank pressure sensor 14 can be positioned within tank 12, or external to tank 12 and coupled with tank 12 (e.g., via tubing or other fitting), to sense a pressure of fluid within tank 12. Tank pressure sensor 14 senses pressure of fluid within tank 12 corresponding to a depth of fluid within tank 12 that corresponds to a pressure exerted by a volume of fluid above tank pressure sensor 14. Though illustrated as including a single tank pressure sensor 14, it should be understood that tank volume monitoring and control system 10 can utilize more than one tank pressure sensor 14 configured to sense pressure of fluid within tank 12 and/or additional tanks.

As illustrated in FIG. 1, tank pressure sensor 14 is coupled (e.g., electrically and/or communicatively) with tank controller 16 to transmit an indication of the sensed fluid pressure within tank 12, such as a voltage representative of the sensed pressure. Tank controller 16, as is further described below, includes processing circuitry and computer-readable memory encoded with instructions that, when executed by the processing circuitry, cause tank controller 16 to determine a correlation scale associated with tank 12 (correlating pressure sensed by tank pressure sensor 14 and a volume of fluid within tank 12) and to determine a volume of fluid within tank 12 based on sensed pressures received from tank pressure sensor 14.

Tank controller 16, remote user interface 20, and server 22 are communicatively coupled to send and receive data via network 18. Network 18 facilitates the communication of data between server 22, remote user interface 20, and tank controller 16. Such data can include, e.g., information such as tank configurations, current tank volume, flow rate (e.g., out of tank 12), user settings, alarm settings, network settings, or other information. Examples of network 18 can include wired or wireless networks or both, such as any one or more of local area networks (LANs), wireless local area networks (WLANs), cellular networks, wide area networks (WANs) such as the Internet, point-to-point communications, or other types of networks. In certain examples, tank controller 16 includes a cellular modem for communicating with a cellular network. Remote user interface 20 can be a desktop computer, a laptop computer, a personal digital assistant (PDA), a tablet computer, a cellular telephone (such as a smartphone), or any other computing device capable of sending and/or receiving data via network 18. In some examples, remote user interface 20 is utilized to access a web application or web service hosted by server 22 to provide a remote user interface for enabling a user to interact with components of tank volume monitoring and control system 10.

As illustrated in FIG. 1, tank volume monitoring and control system 10 can further include storage controller 24 and data storage 26. Data storage 26 can be a database, a storage area network (SAN), or other data storage structure and/or device(s) that store data usable by tank volume monitoring and control system 10 for later access and retrieval. Storage controller 24 manages data communications between data storage 26, server 22, or other components in communication with network 18. In other examples, storage controller 24 can be directly coupled to network 18. In operation, tank controller 16 determines a correlation scale associated with tank 12 that relates pressure sensed by tank pressure sensor 14 and a volume of fluid within tank 12. As is further described below, rather than require linear dimensions of tank 12 to determine the correlation scale, tank controller 16 determines the correlation scale based on information that may be more readily available to an operator, such as an initial volume of fluid within tank 12, an upper threshold volume of tank 12 (e.g., a maximum volumetric capacity of tank 12), and a volume of fluid within tank 12 at a location corresponding to tank pressure sensor 14. Tank controller 16 determines a current tank volume during operation of tank volume monitoring and control system 10 based on the determined correlation scale and an indication of a pressure of fluid within tank 12 acquired by tank pressure sensor 14. As such, tank controller 16, implementing techniques of this disclosure, can decrease the time, effort, and corresponding cost associated with determining the correlation scale, thereby enhancing usability of tank volume monitoring and control system 10.

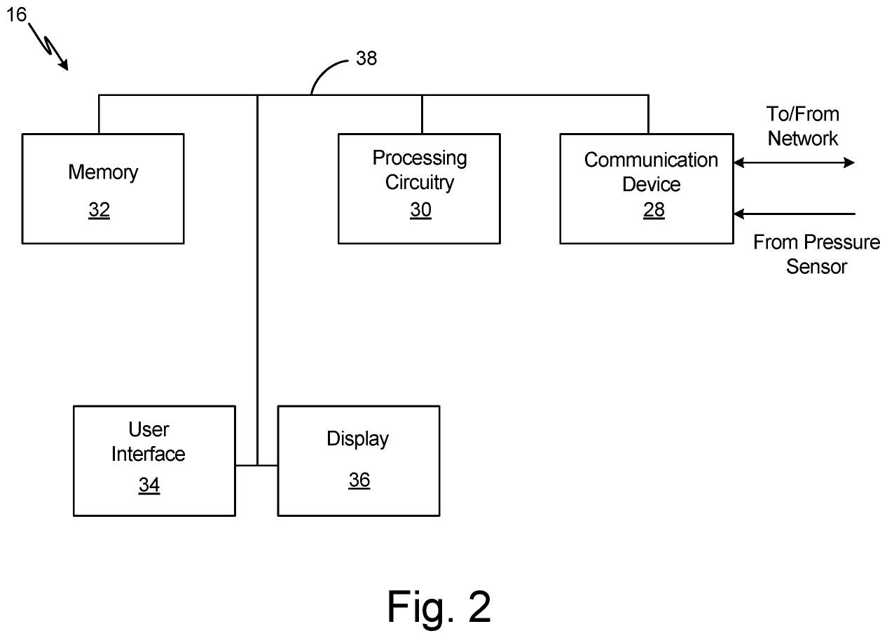

FIG. 2 is a schematic block diagram showing further details of tank controller 16. As illustrated in FIG. 2, tank controller 16 includes communication device 28, processing circuitry 30, computer-readable memory 32, user interface 34, and display 36. Components of tank controller 16 (i.e., components 28, 30, 32, 34, and 36) are interconnected via data bus 38. Tank controller 16 utilizes communication device 28 to communicate with external devices, such as to receive indications of sensed pressures (e.g., sensed pressure values and/or voltage or other indications indicative of sensed pressure values) from tank pressure sensor 14 (FIG. 1) and to communicate with components of tank volume monitoring and control system 10 via network 18 (FIG. 1).

Processing circuitry 30 is configured to implement functionality and/or process instructions for execution within tank controller 16. For instance, processing circuitry 30 can be capable of processing instructions stored in computer-readable memory 32. Examples of processing circuitry 30 can include any one or more of a microprocessor, a central processing unit (CPU), a graphics processing unit (GPU), a digital signal processor (DSP), an application specific integrated circuit (ASIC), a field-programmable gate array (FPGA), or other equivalent discrete or integrated logic circuitry.

Computer-readable memory 32 can be configured to store information within tank controller 16 during operation. In some examples, computer-readable memory 32 is used to store program instructions for execution by processing circuitry 30. Computer-readable memory 32 can be used by software or applications executing on tank controller 16 to temporarily store information during program execution. Computer-readable memory, in some examples, is described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). Computer-readable memory 32, in some examples, includes volatile and/or non-volatile memory. Examples of volatile memory can include random access memory (RAM), dynamic random access memory (DRAM), static random access memory (SRAM), and other forms of volatile memory. Examples of non-volatile memory can include magnetic hard discs, optical discs, floppy discs, flash memory, or forms of electrically programmable memory (EPROM) or electrically erasable and programmable (EEPROM) memory.

As illustrated in FIG. 2, tank controller 16 can include user interface 34 and display 36. User interface 34 is configured to receive input from and/or provide output to a user. Examples of user interface 34 can include any one or more of a keyboard, mouse, microphone, camera device, presence-sensitive and/or touch-sensitive interface, a sound card, a video graphics card, a speaker, or other type of device configured to receive input from and/or provide output to a user. Display 36 can be a liquid crystal display (LCD), organic light emitting diode (OLED) display, cathode ray tube (CRT) display, a segmented display (e.g., a seven segment display), or any other type of display capable of presenting graphical information to a user. In some examples, display 36 can be a presence-sensitive and/or touch-sensitive display that presents a graphical user interface and receives input in the form of user gestures (e.g., touch gestures). In certain examples, display 36 can be and/or include light emitting diodes (LEDs) or other indicators. In yet other examples, display 36 can be remote from and operatively coupled (e.g., electrically and/or communicatively coupled) with tank controller 16, such as a display of a smartphone, tablet computer, or other remote device and/or display.

Tank controller 16, in operation, utilizes display 36 to present information corresponding to operational parameters of tank volume monitoring and control system 10, such as a current fluid volume of tank 12, a percentage of a volumetric capacity of tank 12 occupied by fluid (e.g., a percent full), a flow rate of fluid exiting tank 12, or other operational parameters. Tank controller 16 receives user inputs regarding, e.g., an initial volume of fluid within tank 12 (e.g., via user interface 34), an upper threshold volume of tank 12 (e.g., a maximum volumetric capacity of tank 12), a volume of fluid within tank 12 at a location of tank pressure sensor 14, or other user inputs during an initialization phase. Tank controller 16 determines a correlation scale for tank 12 based on a current sensed pressure received from tank pressure sensor 14 and one or more of the initialization inputs. The correlation scale relates sensed pressures received from tank pressure sensor 14 to the volume of fluid within tank 12.

During a runtime phase of tank volume monitoring and control system 10, tank controller 16 receives sensed pressure data from tank pressure sensor 14 and determines a volume of fluid within tank 12 based on the determined correlation scale and the received sensed pressure. Tank controller 16 outputs an indication of the volume of fluid within tank 12, such as at display 36 and/or via communication message via communication device 28 (e.g., to a remote device, such as remote user interface 20 of FIG. 1).

In some examples, tank controller 16 generates and outputs alarms based on a monitored volume of fluid within tank 12. For instance, such alarms can include low tank volume alarms, maximum tank volume notifications, shutoff volume alarms, or other alarms. In certain examples, tank controller 16 monitors an outflow and/or inflow of fluid from/to tank 12, such as via pump signals or other flow monitoring techniques. Tank controller 16 can compare an expected volume of fluid within tank 12 (e.g., based on an initial volume of fluid and the outflow/inflow of fluid) and the volume of fluid determined based on the sensed pressure acquired by tank pressure sensor 14. Tank controller 16 can output an alarm, notification, or other message in response to determining that the expected volume of fluid within tank 12 deviates from the determined volume of fluid by a threshold volume, thereby eliminating the need for a flow meter in some examples. In some examples, monitoring and alarm operations of tank controller 16 can include notifications (e.g., to an operator) regarding potential repairs or other maintenance to be scheduled. For instance, alarms and/or notifications can relate to: poor correlation and/or efficiency loss due to inaccurate calibration, pump seal and/or check valve seal leaks; detection of low or no outflow from tank 12 due to, e.g., a pump losing prime, a shutoff valve closure, or clogging of fluid lines; and unanticipated outflow from tank 12 due to, e.g., leaks and/or theft of fluid.

Accordingly, tank controller 16 determines a correlation scale for tank 12 that relates sensed pressure received from tank pressure sensor 14 to a volume of fluid within tank 12 using inputs that are more readily available to an operator than the linear dimensions of tank 12. Tank controller 16 determines a volume of fluid within tank 12 (e.g., continuously during runtime), outputs the volume, and monitors the volume level to generate alarms or other notifications to increase operator awareness of the operational state of tank volume monitoring and control system 10.

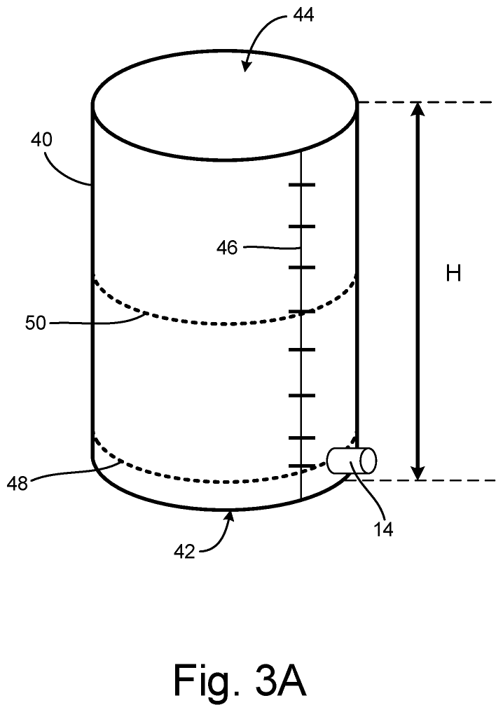

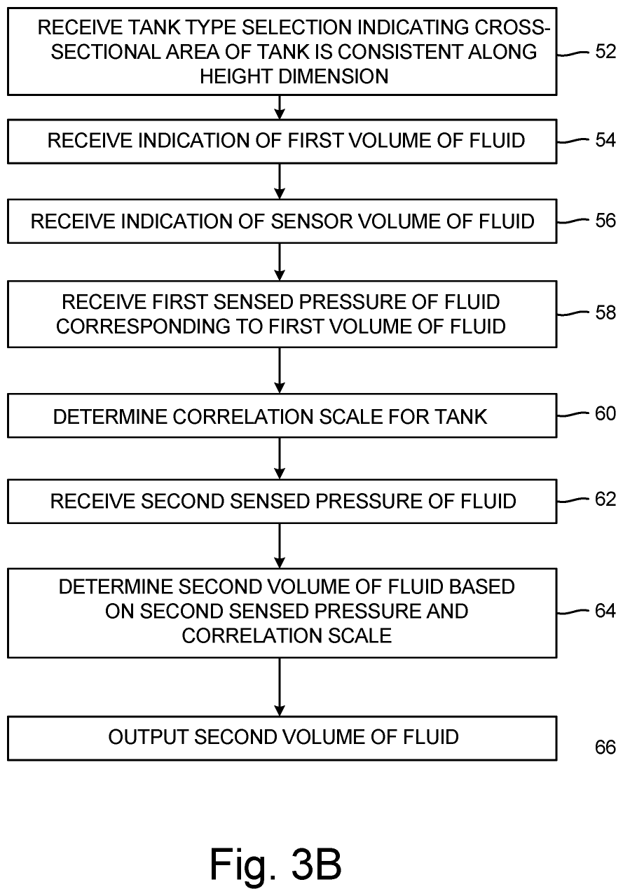

FIG. 3A is a perspective view of vertically-oriented tank 40 having a consistent horizontal cross-section along a height dimension H of tank 40. As illustrated in FIG. 3A, tank 40 has height dimension H extending from base 42 to top 44. Tank pressure sensor 14 is disposed (e.g., within tank 40, or externally to tank 40 and coupled to an interior of tank 40) at a location near base 42. In the example of FIG. 3A, tank 40 is vertically-oriented such that height dimension H aligns generally with gravity. Strap chart 46 is located on an exterior of tank 40 and extends from base 42 to top 44 along height dimension H. Strap charts, found on many tanks, provide a volume of the tank for a given reference line height (i.e., measured from the base along a height dimension). Strap chart 46 includes a plurality of such reference lines, each indicating a volume of fluid within tank 40 at a height of the respective reference line.

As illustrated in FIG. 3A, a horizontal cross-section of tank 40 taken perpendicularly to height dimension H is consistent (i.e., invariant) along height dimension H. While the example of FIG. 3A illustrates tank 40 as a vertically-oriented cylinder (i.e., having a circular cross-section perpendicular to height dimension H), tank 40 can be any shape having a consistent horizontal cross-section along height dimension H.

Tank controller 16 (FIGS. 1 and 2) determines a correlation scale for tank 40 that relates a sensed pressure acquired by tank pressure sensor 14 to a volume of fluid within tank 40. During an initialization phase, a user enters a current volume of fluid within tank 40, such as by using a height of the fluid (e.g., height 50) and a listed volume at a corresponding reference line of strap chart 46. In addition, the user enters a volume of fluid corresponding to a volume of fluid in the tank at a location of tank pressure sensor 14. For instance, as illustrated in FIG. 3A, tank pressure sensor 14 can be disposed at a height from base 42. As such, a volume of fluid within tank 40 at the height of tank pressure sensor 14 (e.g., height 48) represents a volume of fluid that is between tank pressure sensor 14 and base 42. The volume of fluid between tank pressure sensor 14 and base 42 does not contribute to the fluid pressure sensed by tank pressure sensor 14. As such, tank controller 16 utilizes the provided volume of fluid in the tank at the location of tank pressure sensor 14 when generating the correlation scale for tank 40 to compensate for the volume of fluid between tank pressure sensor 14 and base 42 that does not contribute to the sensed fluid pressure. Accordingly, as is further described below, tank controller 16 determines a correlation scale for tank 40 using inputs that are readily available to the user (i.e., current tank volume and volume of fluid at the sensor height) without requiring the linear dimensions of tank 40.

FIG. 3B is a flow diagram illustrating example operations of tank controller 16 to determine a volume of fluid within tank 40 of FIG. 3A. For purposes of clarity and ease of discussion, the example operations of FIG. 3B are described below within the context of tank volume monitoring and control system 10 of FIG. 1.

A tank type selection indicating that a horizontal cross-sectional area of the tank is consistent along a height dimension of the tank is received (Step 52). For example, tank controller 16 can present, e.g., at user interface 34, a tank type selection prompt that enables a user to select whether the tank has a consistent horizontal cross-section along the height dimension, an inconsistent (i.e., varying) horizontal cross-section along the height dimension, or is a custom shape having an inconsistent (i.e., varying) horizontal cross-section along the height dimension. Tank controller 16 can receive an indication of a tank type selection indicating that a cross-sectional area of tank 40 is consistent along the height dimension H.

An indication of a first volume of fluid is received (Step 54). For instance, tank controller 16 can receive an indication of a first volume of fluid entered by a user corresponding to an initial volume of fluid within tank 40, such as the volume of fluid at height 50. An indication of a sensor volume of fluid corresponding to a volume of fluid in the tank at a location of the pressure sensor is received (Step 56). For example, tank controller 16 can receive an indication of the volume of fluid within tank 40 at height 48 corresponding to the height of tank pressure sensor 14. A first sensed pressure of fluid within the tank corresponding to the first volume of fluid is received (Step 58). For instance, tank controller 16 can receive the sensed pressure of the first volume of fluid within tank 40 from tank pressure sensor 14.

A correlation scale for the tank is determined based on the first sensed pressure, the first volume of fluid, and the sensor volume of fluid (Step 60). For example, tank controller 16 can determine a correlation scale for tank 40 as the linear correlation between the first volume of fluid at the first sensed pressure and the sensor volume of fluid at a zero-fluid pressure. That is, tank controller 16 can determine the correlation scale for tank 40 based on the slope of the line extending between the first volume of fluid at the first sensed pressure and the sensor volume of fluid at a zero-fluid pressure. The zero-fluid pressure is a sensed pressure acquired by tank pressure sensor 14 when the level of fluid within tank 40 is below the height of tank pressure sensor 14 (i.e., a fluid between the location of tank pressure sensor 14 and base 42, or no fluid within tank 40).

Tank pressure sensor 14 can be calibrated such that the zero-fluid pressure is a value of zero, or a non-zero number (e.g., a standard day pressure).

A second sensed pressure of fluid within the tank is received (Step 62). For example, tank controller 16 can receive a second sensed pressure signal corresponding to a second volume of fluid within tank 40 (e.g., a volume of fluid corresponding to a height that is different than height 50) from tank pressure sensor 14. A second volume of fluid within the tank is determined based on the second sensed pressure and the correlation scale (Step 64). For instance, tank controller 16 can determine the second volume of fluid by linearly interpolating (or extrapolating) the correlation scale to derive the second volume from the second sensed pressure.

An indication of the second volume of fluid is output (Step 66). For instance, tank controller 16 can provide the second volume of fluid for display at display 36 and/or can output the second volume of fluid within a communication message via communication device 28 for use by remote user interface 20, server 22, or other remote device communicatively connected with tank controller 16. In some examples, tank controller 16 receives an indication of an upper threshold volume of tank 40 (e.g., a maximum volumetric capacity of tank 40, or an upper threshold volume that is less than a maximum volumetric capacity of tank 40), such as via user interface 34. Tank controller 16 can determine and output a percentage of the upper threshold volume of tank 40 occupied by fluid, such as by dividing the second volume by the upper threshold volume.

As such, tank controller 16 determines a correlation scale for tank 40 having a consistent cross-section along a height dimension, and determines (e.g., iteratively determines) a volume of fluid within tank 40 during operation of the system.

Rather than require the linear dimensions of tank 40, tank controller 16 determines the correlation scale for tank 40 based on inputs that may be more readily measureable by an operator, such as the initial volume of fluid within tank 40 and a volume of fluid at a location of tank pressure sensor 14 (each measureable using, e.g., strap chart 46). Accordingly, tank controller 16 implementing techniques of this disclosure can decrease the time, effort, and cost associated with initializing the system for volume determinations, thereby increasing usability of the system.

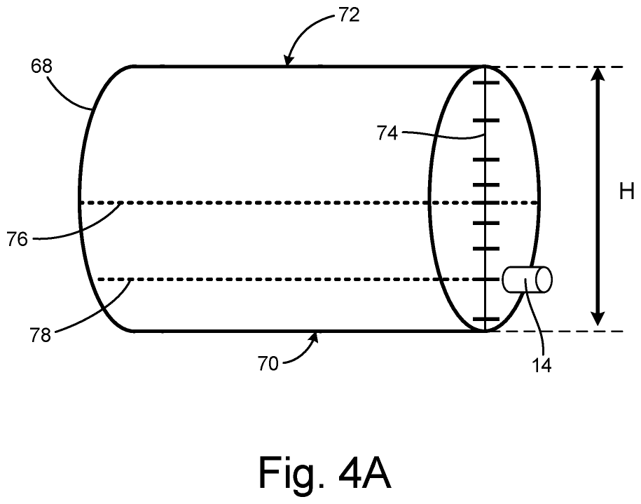

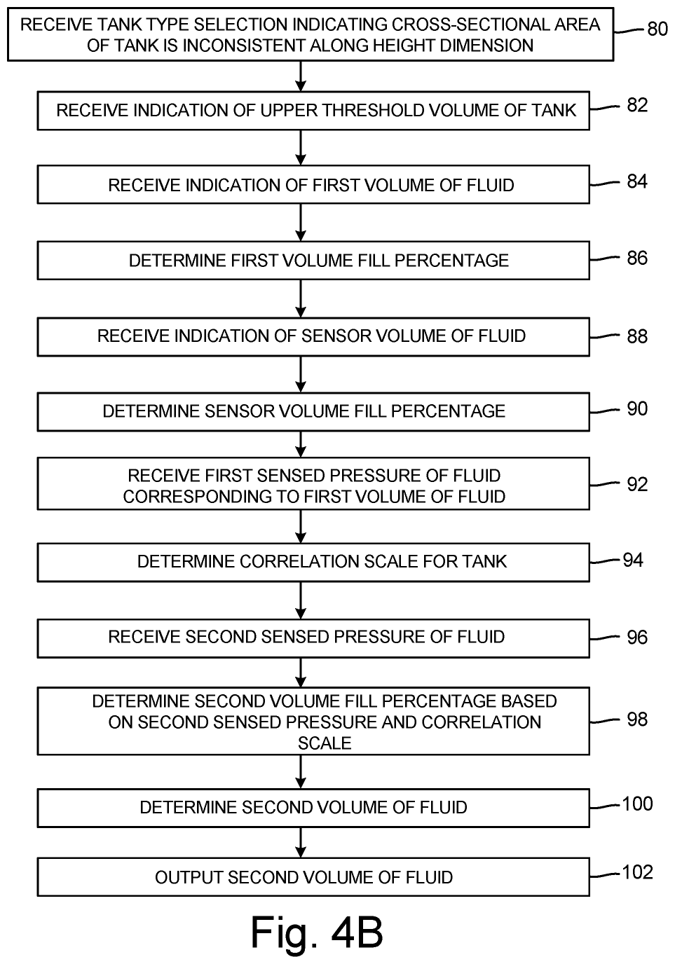

FIG. 4A is a perspective view of horizontally-oriented tank 68 having an inconsistent horizontal cross-section along height dimension H of tank 68. As illustrated in FIG. 4A, tank 68 has height dimension H extending from base 70 to top 72. Tank pressure sensor 14 is disposed at a location near base 70. Strap chart 74 is located on an exterior of tank 68 and extends from base 42 to top 44 along height dimension H. Strap chart 68 includes a plurality of reference lines, each indicating a volume of fluid within tank 68 at a height of the respective reference line.

In the example of FIG. 4A, tank 68 is horizontally-oriented such that height dimension H extending between base 70 and top 72 aligns generally with gravity. A horizontal cross-section of tank 68 taken perpendicularly to height dimension H is inconsistent (i.e., varying) along height dimension H. As illustrated in FIG. 4A, reference lines of strap chart 74 are not evenly spaced, reflecting the inconsistent cross-section of tank 68 along height dimension H. While the example of FIG. 4A illustrates tank 68 as a horizontally-oriented cylinder, tank 68 can be take the form of other shapes having an inconsistent horizontal cross-section along height dimension H.

Tank controller 16 (FIGS. 1 and 2) determines a correlation scale for tank 68 that relates a sensed pressure acquired by tank pressure sensor 14 to a volume of fluid within tank 68. During an initialization phase, a user enters a current volume of fluid within tank 68, such as by using a height of the fluid (e.g., height 76) and a listed volume at a corresponding reference line of strap chart 74. Tank controller 16 also receives an indication of an upper threshold volume of tank 68 (e.g., user entered or otherwise provided to tank controller 16). The upper threshold volume, in some examples, is a maximum volumetric capacity of tank 68. In other examples, the upper threshold volume can be a volume that is less than the maximum volumetric capacity of tank 68, such as when tank 68 is not filled to maximum capacity during operation. In addition, the user enters a volume of fluid corresponding to a volume of fluid in the tank at a location of tank pressure sensor 14. For instance, a user can utilize strap chart 74 to enter a volume of fluid corresponding to height 78 of tank pressure sensor 14.

As is further described below, tank controller 16 determines a correlation scale for tank 68 based on the current volume of fluid within tank 68, an upper threshold volume of tank 68, and a volume of fluid within tank 68 corresponding to the height of tank pressure sensor 14. Accordingly, tank controller 16 determines the correlation scale for tank 68 using inputs that may be more easily measured by a user than linear dimensions of tank 68.

FIG. 4B is a flow diagram illustrating example operations of tank controller 16 to determine a volume of fluid within tank 68 of FIG. 4A. For purposes of clarity and ease of discussion, the example operations of FIG. 4B are described below within the context of tank volume monitoring and control system 10 of FIG. 1.

A tank type selection indicating that a horizontal cross-sectional area of the tank is inconsistent along a height dimension of the tank is received (Step 80). For example, tank controller 16 can receive an indication of a tank type selection indicating that a horizontal cross-sectional area of tank 68 is inconsistent along the height dimension H.

An indication of an upper threshold volume of the tank is received (Step 82). For instance, tank controller 16 can receive an indication of an upper threshold volume of tank 68 corresponding to a maximum volumetric capacity of tank 68 or an upper threshold volume that is less than a maximum volumetric capacity of tank 68. An indication of a first volume of fluid within the tank is received (Step 84). For example, tank controller 16 can receive an indication of a first volume of fluid entered by a user corresponding to an initial volume of fluid within tank 68, such as the volume of fluid at height 76. A first volume fill percentage representing a percentage of the upper threshold volume of the tank occupied by the first volume of fluid within the tank is determined (Step 86). For example, tank controller 16 can determine the first volume fill percentage by dividing the first volume of fluid by the upper threshold volume of tank 68. An indication of a sensor volume of fluid corresponding to a volume of fluid in the tank at a location of the pressure sensor is received (Step 88). For example, tank controller 16 can receive an indication of the volume of fluid within tank 68 at height 78 corresponding to the height of tank pressure sensor 14.

A sensor volume fill percentage representing a percentage of the upper threshold volume of the tank occupied by the sensor volume of fluid is determined (Step 90). For instance, tank controller 16 can determine the sensor volume fill percentage by dividing the sensor volume of fluid by the upper threshold volume of tank 68. A first sensed pressure of fluid within the tank corresponding to the first volume of fluid is received (Step 92). For instance, tank controller 16 can receive the sensed pressure of the first volume of fluid within tank 68 from tank pressure sensor 14.

A correlation scale of the tank is determined (Step 94). For example, tank controller 16 can determine the correlation scale for tank 68 as the linear correlation between the first volume fill percentage at the first sensed pressure and the sensor volume fill percentage at a zero-fluid pressure, such as a zero-fluid pressure calibrated to a value of zero, or a zero-fluid pressure calibrated to a non-zero number (e.g., a standard day pressure). A second sensed pressure of fluid within the tank is received (Step 96). For example, tank controller 16 can receive a second sensed pressure corresponding to a second volume of fluid within tank 68 (e.g., a volume of fluid corresponding to a height that is different than height 76) from tank pressure sensor 14. A second volume fill percentage representing a percentage of the upper threshold volume of the tank occupied by the second volume of fluid within the tank is determined based on the second sensed pressure and the correlation scale (Step 98). For instance, tank controller 16 can determine the second volume fill percentage by linearly interpolating (or extrapolating) the correlation scale to derive the second volume fill percentage from the second sensed pressure.

A second volume of fluid within the tank is determined based on the second volume fill percentage and the upper threshold volume of the tank (Step 100). For example, tank controller 16 can determine the second volume of fluid by multiplying the second volume fill percentage and the upper threshold volume of tank 68. An indication of the second volume of fluid is output (Step 102). For instance, tank controller 16 can provide the second volume of fluid for display at display 36 and/or can output the second volume of fluid within a communication message via communication device 28 for use by remote user interface 20, server 22, or other remote device communicatively connected with tank controller 16.

Accordingly, tank controller 16 determines a correlation scale for tank 68 having an inconsistent cross-section along a height dimension, and determines (e.g., iteratively determines) a volume of fluid within tank 68 during operation of the system. The correlation scale is determined based on inputs that may be more readily measureable by an operator (i.e., initial tank volume, upper threshold tank volume, and sensor volume) than the linear dimensions of the tank.

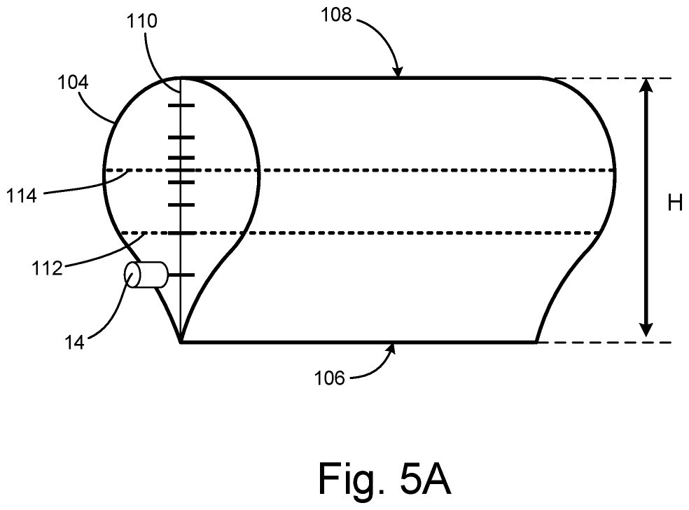

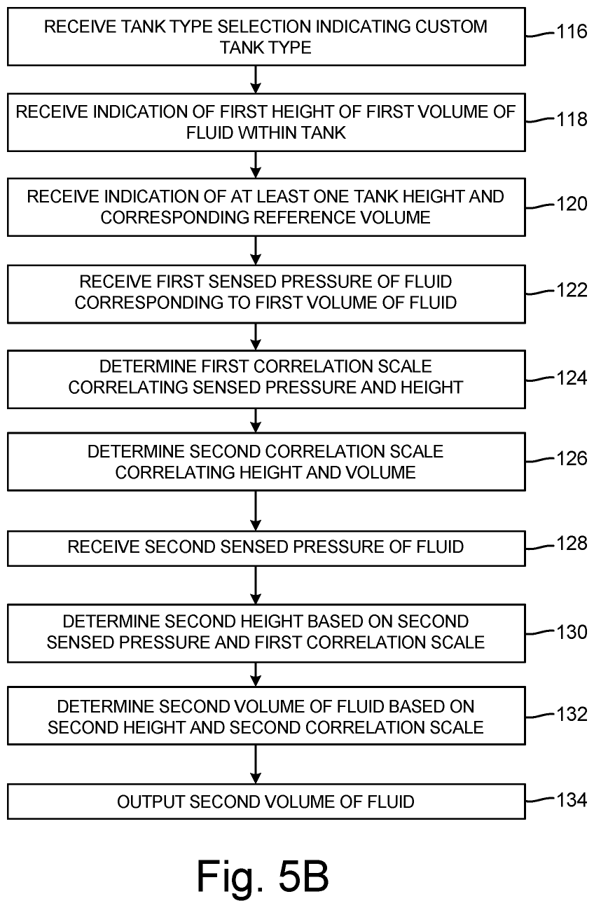

FIG. 5A is a perspective view of custom tank 104 having an inconsistent horizontal cross-section along height dimension H of tank 104. As illustrated in FIG. 5A, tank 104 has height dimension H extending from base 106 to top 108. Tank pressure sensor 14 is disposed at a location near base 106. Strap chart 110 is located on an exterior of tank 108 and extends from base 106 to top 110 along height dimension H. Strap chart 110 includes a plurality of reference lines, each indicating a volume of fluid within tank 104 at a height above base 106 of the respective reference line.

In the example of FIG. 5A, tank 104 is horizontally oriented such that height dimension H extending between base 106 and top 108 aligns generally with gravity. A horizontal cross-section of tank 104 taken perpendicularly to height dimension H is inconsistent (i.e., varying) along height dimension H. As illustrated in FIG. 5A, reference lines of strap chart 110 are not evenly spaced, reflecting the inconsistent cross-section of tank 104 along height dimension H. During an initialization phase, a user enters a current height of fluid within tank 104 above base 106, such as height 112, as well as a height of sensor 14 from base 106. In addition, the user enters the height of at least one reference line of strap chart 110 above base 106 and the corresponding volume, such as height 114 and the corresponding volume within tank 104 at height 114 (e.g., using strap chart 110). In some embodiments, the user can enter a plurality of reference heights and corresponding volumes, such as twenty or more such reference heights and volumes.

As is further described below, tank controller 16 (FIGS. 1 and 2) determines a first correlation scale for tank 104 that relates a sensed pressure acquired by tank pressure sensor 14 to a height of fluid within tank 104 above base 106 based on the current height of fluid within tank 104 and a current pressure sensed by tank pressure sensor 14. Tank controller 16 determines a second correlation scale for tank 104 that relates a height above base 106 to a corresponding volume of fluid within tank 104 based on the height of the at least one reference line of strap chart 110 and corresponding volume entered by the user. Accordingly, tank controller 16 determines correlation scales for tank 104 that enable tank controller 16 to determine a volume of fluid within tank 104 using inputs that are more easily measurable by the user than linear dimensions of the tank.

FIG. 5B is a flow diagram illustrating example operations of tank controller 16 to determine a volume of fluid within tank 104 of FIG. 5A. For purposes of clarity and ease of discussion, the example operations of FIG. 5B are described below within the context of tank volume monitoring and control system 10 of FIG. 1.

A tank type selection indicating that the tank is a custom tank having a horizontal cross-sectional area that is inconsistent (i.e., varying) along a height dimension of the tank is received (Step 116). For instance, tank controller 16 can receive an indication of a tank type selection indicating that tank 104 is a custom tank having a horizontal cross-sectional area that is inconsistent along height dimension H.

An indication of a first height of a first volume of fluid extending above a base of the tank is received (Step 118). For instance, tank controller 16 can receive an indication of height 112 of a current volume of fluid within tank 104. An indication of at least one height extending above the base of the tank and a corresponding reference volume of the tank at the at least one height are received (Step 120). For example, tank controller 16 can receive height 114 and a corresponding volume of tank 104 at height 114. In some examples, tank controller 16 can receive a plurality of heights and corresponding reference volumes, such as multiple (e.g., each) height and corresponding volume of strap chart 110. In certain examples, tank controller 16 identifies a greatest height of the received plurality of heights and assigns the corresponding reference volume of the greatest height as an upper threshold volume of tank 104. In such examples, tank controller 16 utilizes the assigned upper threshold volume of tank 104 to determine a fill percentage of tank 104 representing a percentage of the upper threshold volume occupied by fluid.

A first sensed pressure of the fluid within the tank corresponding to the first volume of fluid is received (Step 122). For example, tank controller 16 can receive the sensed pressure of the first volume of fluid within tank 104 from tank pressure sensor 14.

A first correlation scale for the tank that correlates pressure sensed by the pressure sensor to height of the fluid within the tank is determined based on the first sensed pressure and the first height of the first volume of fluid within the tank (Step 124). For instance, tank controller 16 can determine the first correlation scale as a linear correlation between the first height of the first volume of fluid within the tank at the first sensed pressure and the height of the pressure sensor from the base of the tank at a zero-fluid pressure, such as a zero-fluid pressure calibrated to a value of zero, or a zero-fluid pressure calibrated to a non-zero number (e.g., a standard day pressure). In certain examples, tank controller 16 can receive an indication of a sensor position that indicates whether tank pressure sensor 14 is disposed above base 106 or below base 106 of tank 104 (e.g., and coupled to the fluid within tank 104 via a fitting or other coupling). In response to receiving an indication that tank pressure sensor 14 is disposed above base 106, tank controller 16 subtracts the pressure sensor height from the fluid height computations. In response to receiving an indication that tank pressure sensor 14 is disposed below base 106, tank controller 16 adds the pressure sensor height to the fluid height computations.

A second correlation scale of the tank that correlates height above the base of the tank to volume of fluid within the tank is determined based on the received indication of the at least one height extending above the base of the tank and the corresponding reference volume of the at least one height (Step 126). In some examples, tank controller 16 can receive a plurality of heights and corresponding reference volumes, such as twenty or more heights and corresponding reference volumes. In such examples, tank controller 16 determines the second correlation scale based on the plurality of heights and the corresponding reference volume of each respective height.

A second sensed pressure of fluid within the tank is received (Step 128). For instance, tank controller 16 can receive a second sensed pressure of fluid within tank 104 from tank pressure sensor 14. A second height extending above the base of the tank is determined based on the second sensed pressure and the first correlation scale (Step 130). For instance, tank controller 16 can determine the second height by applying the first correlation scale to the second sensed pressure to derive the second height.

A second volume of fluid within the tank is determined based on the second height and the second correlation scale (Step 132). For example, tank controller 16 can linearly interpolate between heights and corresponding reference volumes of the second correlation scale to derive the second volume of fluid within tank 104 based on the second height. An indication of the second volume of fluid is output (Step 134). For instance, tank controller 16 can provide the second volume of fluid for display at display 36 and/or can output the second volume of fluid within a communication message via communication device 28 for use by remote user interface 20, server 22, or other remote device communicatively connected with tank controller 16.

Accordingly, a controller device implementing techniques described herein determines a volume of fluid within a tank using fluid pressure acquired by a pressure sensor disposed within (or otherwise coupled with) the tank. Rather than require that the controller device be provided with two or more linear dimensions of the tank, techniques of this disclosure enable the controller device to determine the fluid volume within the tank using inputs that are more readably available to, or measurable by, an operator. In various embodiments of the present disclosure, tank controller 16 determines a volume of fluid within a tank without measuring and/or utilizing any of the following parameters:

fluid and/or tank weight; pump cycles, pump actuation and/or actuation timing, pump outflow, or other pump information; volumetric or other fluid flow information; internal or external tank dimensions; and/or non-pressure based fluid level measurements. As such, techniques of this disclosure can decrease the time, effort, and cost of initialization of the system, thereby enhancing system usability of cost effective operations.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

In some embodiments, some component(s) or step(s) may be omitted for optimizing design, function, economy, or any combination thereof, and therefore, the omission of any such component(s) or step(s) shall be a negative limitation, if so claimed.

The present disclosure is made using various embodiments to highlight various inventive aspects. Modifications can be made to the embodiments presented herein without departing from the scope of the invention. As such, the scope of the invention is not limited to the embodiments disclosed herein.

1. A method comprising:
receiving, by a controller device, an indication of a first volume of fluid within a tank;
receiving, by the controller device, an indication of a sensor volume of fluid corresponding to a volume of the fluid in the tank at a location of a pressure sensor;
receiving, by the controller device from the pressure sensor, a signal representing a first sensed pressure of the fluid within the tank corresponding to the first volume of fluid;
determining, by the controller device, a correlation scale for the tank based on the first sensed pressure, the first volume of fluid, and the sensor volume of fluid;
receiving, by the controller device from the pressure sensor, a second sensed pressure of the fluid within the tank;
determining, by the controller device, a second volume of fluid within the tank based on the second sensed pressure and the correlation scale; and
outputting, by the controller device, an indication of the second volume of fluid.

2. The method of claim 1,
wherein the correlation scale correlates pressure sensed by the pressure sensor to volume of fluid within the tank.

3. The method of claim 1,
wherein determining the correlation scale for the tank comprises determining the correlation scale as a linear correlation between the first volume of fluid at the first sensed pressure and the sensor volume of fluid at a zero-fluid pressure.

4. The method of claim 3, further comprising:
receiving, by the controller device, an indication that a cross-sectional area of the tank is consistent along a height dimension of the tank extending from a base of the tank to a top of the tank; and
wherein determining the correlation scale for the tank as the linear correlation between the first volume of fluid at the first sensed pressure and the sensor volume of fluid at the zero-fluid pressure is responsive to receiving the indication that the cross-sectional area of the tank is consistent along the height dimension of the tank.

5. The method of claim 1, further comprising:
receiving, by the controller device, an upper threshold volume of the tank;
determining, by the controller device based on the first volume of fluid and the upper threshold volume, a first volume fill percentage representing a percentage of the upper threshold volume of the tank occupied by the first volume of fluid within the tank; and
determining, by the controller device based on the sensor volume of fluid and the upper threshold volume, a sensor volume fill percentage representing a percentage of the upper threshold volume of the tank occupied by the sensor volume of fluid;
wherein determining the correlation scale for the tank comprises determining the correlation scale for the tank as a linear correlation between:
the first volume fill percentage at the first sensed pressure; and
the sensor volume fill percentage at a zero-fluid pressure.

6. The method of claim 5,
wherein determining the second volume of fluid within the tank based on the second sensed pressure and the correlation scale comprises:
determining, based on the second sensed pressure and the correlation scale, a second volume fill percentage representing a percentage of the upper threshold volume of the tank occupied by the second volume of fluid within the tank; and
determining the second volume of fluid based on the second volume fill percentage and the upper threshold volume of the tank.

7. The method of claim 5, further comprising:
receiving, by the controller device, an indication that a cross-sectional area of the tank is inconsistent along a height dimension of the tank extending from a base of the tank to a top of the tank; and
wherein determining the correlation scale for the tank as the linear correlation between the first volume fill percentage at the first sensed pressure and the sensor volume fill percentage at the zero-fluid pressure is responsive to receiving the indication that the cross-sectional area of the tank is inconsistent along the height dimension of the tank.

8. The method of claim 5,
wherein the upper threshold volume of the tank is a maximum volumetric capacity of the tank.

9. A controller device comprising:
processing circuitry; and
computer-readable memory encoded with instructions that, when executed by the processing circuitry, cause the controller device to:
determine a correlation scale for a tank based on a received indication of a first volume of fluid within a tank, a first pressure of the first volume of fluid within the tank sensed by a pressure sensor disposed at a location, and a received indication of a sensor volume of fluid corresponding to a volume of the fluid in the tank at the location of the pressure sensor;
determine a second volume of fluid within the tank based on the correlation scale and a second pressure of the second volume of fluid within the tank sensed by the pressure sensor; and
output an indication of the second volume of fluid.

10. The controller device of claim 9,
wherein the computer-readable memory is further encoded with instructions that, when executed by the processing circuity, cause the controller device to determine the correlation scale for the tank as a linear correlation between the first volume of fluid at the first sensed pressure and the sensor volume of fluid at a zero-fluid pressure.

11. The controller device of claim 10,
wherein the computer-readable memory is further encoded with instructions that, when executed by the processing circuity, cause the controller device to determine the correlation scale for the tank as the linear correlation between the first volume of fluid at the first sensed pressure and the sensor volume of fluid at the zero-fluid pressure responsive to receiving an indication that the cross-sectional are of the tank is consistent along a height dimension of the tank, the height dimension extending from a base of the tank to a top of the tank.

12. The controller device of claim 9,
wherein the computer-readable memory is further encoded with instructions that,
when executed by the processing circuity, cause the controller device to:
determine, based on the first volume of fluid and an upper threshold volume of the tank, a first volume fill percentage representing a percentage of the upper threshold volume of the tank occupied by the first volume of fluid within the tank;
determine, based on the sensor volume of fluid and the upper threshold volume, a sensor volume fill percentage representing a percentage of the upper threshold volume of the tank occupied by the sensor volume of fluid; and
determine the correlation scale of the tank as a linear correlation between:
the first volume fill percentage at the first sensed pressure; and
the sensor volume fill percentage at a zero-fluid pressure.

13. The controller device of claim 12,
wherein the computer-readable memory is further encoded with instructions that, when executed by the processing circuitry, cause the controller device to:
determine, based on the second sensed pressure and the correlation scale, a second volume fill percentage representing a percentage of the upper threshold volume of the tank occupied by the second volume of fluid within the tank; and
determine the second volume of fluid based on the second volume fill percentage and the upper threshold volume of the tank.

14. The controller device of claim 12,
wherein the computer-readable memory is further encoded with instructions that, when executed by the processing circuitry, cause the controller device to:
determine the correlation scale for the tank as the linear correlation between the first volume fill percentage at the first sensed pressure and the sensor volume fill percentage at the zero-fluid pressure responsive to receiving an indication that a cross-sectional area of the tank is inconsistent along a height dimension of the tank, the height dimension of the tank extending from a base of the tank to a top of the tank.

15. The controller device of claim 12,
wherein the upper threshold volume of the tank is a maximum volumetric capacity of the tank.

16. A method comprising:
receiving, by a controller device, an indication of a first height of a first volume of fluid within a tank, the first height extending above a base of the tank;
receiving, by the controller device, an indication of at least one height extending above the base of the tank and a corresponding reference volume of the tank at the at least one height;
receiving, by the controller from a pressure sensor, a first sensed pressure signal of the fluid within the tank corresponding to the first volume of fluid;
determining, by the controller device, a first correlation scale for the tank based on the first sensed pressure and the first height of the first volume of fluid within the tank, the first correlation scale correlating pressure sensed by the pressure sensor to height of the fluid within the tank;
determining, by the controller device, a second correlation scale for the tank based on the received indication of the at least one height extending above the base of the tank and the corresponding reference volume of the at least one height, the second correlation scale correlating height above the base of the tank to volume of fluid within the tank;
receiving, by the controller device from the pressure sensor, a second sensed pressure signal of the fluid within the tank;
determining, by the controller device, a second height extending above the base of the tank based on the second sensed pressure and the first correlation scale;
determining, by the controller device, a second volume of fluid within the tank based on the second height and the second correlation scale; and
outputting, by the controller device, an indication of the second volume of fluid.

17. The method of claim 16, further comprising:
receiving, by the controller device, an indication of a height of the pressure sensor from the base of the tank;
wherein determining the first correlation scale of the tank comprises determining the first correlation scale as a linear correlation between the first height of the first volume of fluid within the tank at the first sensed pressure and the height of the pressure sensor from the base of the tank at a zero-fluid pressure.

18. The method of claim 16,
wherein receiving the indication of the at least one height extending above the base of the tank and the corresponding reference volume of the at least one height comprises receiving a plurality of heights extending above the base of the tank and a corresponding reference volume of each respective height; and
wherein determining the second correlation scale comprises determining the second correlation scale based on the plurality of heights and the corresponding reference volume of each respective height.

19. The method of claim 18,
wherein determining the second volume of fluid within the tank based on the second height and the second correlation scale comprises linearly interpolating between the plurality of heights and the corresponding reference volumes of the plurality of heights to determine the second volume of fluid.

20. The method of claim 18, further comprising:
identifying, by the controller device, a greatest height of the received plurality of heights;
assigning, by the controller device, the corresponding reference volume of the identified greatest height as an upper threshold volume of the tank;
determining, by the controller device based on the second volume of fluid within the tank and the upper threshold volume of the tank, a fill percentage representing a percentage of the upper threshold volume of the tank occupied by the second volume of fluid; and
outputting, by the controller deice, the fill percentage.

21. A controller device comprising:
processing circuitry; and
computer-readable memory encoded with instructions that, when executed by the processing circuitry, cause the controller device to:
determine a first correlation scale for a tank based on a first sensed pressure signal of a first volume of fluid within the tank received from a pressure sensor and a first height of the first volume of fluid within the tank, the first correlation scale correlating pressure sensed by the pressure sensor to height of the fluid within the tank;
determine a second correlation scale for the tank based a received indication of at least one height extending above a base of the tank and a corresponding reference volume of the tank at the least one height, the second correlation scale correlating height above the base of the tank to volume of fluid within the tank;
determine a second height extending above the base of the tank based on the second correlation scale and a second sensed pressure signal of fluid within the tank received from the pressure sensor;
determine a second volume of fluid within the tank based on the second height and the second correlation scale; and
output an indication of the second volume of fluid.

22. The controller device of claim 21,
wherein the computer-readable memory is further encoded with instructions that, when executed by the processing circuitry, cause the controller device to determine the first correlation scale of the tank as a linear correlation between the first height of the first volume of fluid within the tank at the first sensed pressure and a height of the pressure sensor from the base of the tank at a zero-fluid pressure.

23. The controller device of claim 21,
wherein the computer-readable memory is further encoded with instructions that, when executed by the processing circuitry, cause the controller device to determine the second correlation scale based on a plurality of heights extending above the base of the tank and a corresponding reference volume of each respective height.

24. The controller device of claim 23,
wherein the computer-readable memory is further encoded with instructions that, when executed by the processing circuitry, cause the controller device to linearly interpolate between the plurality of heights and the corresponding reference volumes of the plurality of heights to determine the second volume of fluid.

25. The controller device of claim 23,
wherein the computer-readable memory is further encoded with instructions that, when executed by the processing circuitry, cause the controller device to:
identify a greatest height of the received plurality of heights;
assign the corresponding reference volume of the identified greatest height as an upper threshold volume of the tank;
determine, based on the second volume of fluid within the tank and the upper threshold volume of the tank, a fill percentage representing a percentage of the upper threshold volume of the tank occupied by the second volume of fluid; and
output the fill percentage.
